(19) United States
(12) Patent Application Publication
(10) Pub. No.: US 2025/0097856 A1
(43) Pub. Date: Mar. 20, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Wenhong CHEN, Dongguan (CN)

(21) Appl. No.: 18/971,529

(22) Filed: Dec. 6, 2024

Related U.S. Application Data
(63) Continuation of application No. PCT/CN2022/124403, filed on Oct. 10, 2022.

(51) Int. Cl. H04W 52/32; H04L 5/00; H04W 72/231

(52) U.S. Cl. CPC H04W 52/325; H04L 5/0051; H04W 72/231

(57) ABSTRACT

A wireless communication method includes: determining, by a terminal device, a number N of PTRS ports used for uplink transmission of X antenna ports, where X is a positive integer greater than 4; determining an antenna port and a transport layer associated with each PTRS port of N PTRS ports; determining power boosting value of each PTRS port of the N PTRS ports; and transmitting, based on the antenna port and the transport layer associated with the each PTRS port, as well as the power boosting value of the each PTRS port, a PTRS on at least some PTRS ports of the N PTRS ports.

### CROSS-REFERENCE TO RELATED APPLICATION

This application is a Continuation Application of PCT/CN2022/124403 filed Oct. 10, 2022, which is incorporated herein by reference in its entirety.

### TECHNICAL FIELD

Embodiments of the present disclosure relate to the field of communications, and in particular, to a wireless communication method, a terminal device, and a network device.

### BACKGROUND

Currently, uplink transmission supports up to 4 physical uplink shared channel (PUSCH) antenna ports. At the same time, in FR2, at most 2 phase tracking reference signal (PTRS) ports may be configured by a network device to be associated with a PUSCH antenna port.

In some scenarios, some advanced terminals may be configured with more transmission links or radio frequency channels, and at this time, may support more PUSCH antenna ports, e.g., 8 PUSCH antenna ports, to further improve uplink transmission performance. In this case, how to transmit a PTRS to support more PUSCH antenna ports and thus improve the uplink transmission performance is an urgent problem that needs to be solved.

### SUMMARY

In a first aspect, there is provided a wireless communication method, including: determining, by a terminal device, a number N of phase tracking reference signal (PTRS) ports used for uplink transmission of X antenna ports, where X is a positive integer greater than 4; determining an antenna port and a transport layer associated with each PTRS port of N PTRS ports; and determining a power boosting value of each PTRS port of the N PTRS ports; and transmitting, based on the antenna port and the transport layer associated with the each PTRS port, as well as the power boosting value of the each PTRS port, a PTRS on at least some PTRS ports of the N PTRS ports.

In a second aspect, there is provided a wireless communication method, including: determining, by a network device, a number N of phase tracking reference signal (PTRS) ports used for uplink transmission of X antenna ports, where X is an integer greater than 4; and determining an antenna port and a transport layer associated with each PTRS port of N PTRS ports; and receiving, based on the number N of the PTRS ports, a PTRS on at least some PTRS ports of the N PTRS ports; and performing, based on a phase measurement result of the PTRS, a channel estimation of a demodulation reference signal (DMRS) or a phase adjustment of a transport layer associated with the N PTRS ports.

In a third aspect, there is provided a terminal device for executing the method in the first aspect or various implementations thereof.

Specifically, the terminal device includes a functional module for executing the method in the above first aspect or various implementations thereof.

In a fourth aspect, there is provided a network device for executing the method in the second aspect or various implementations thereof.

Specifically, the network device includes a functional module for executing the method in the above second aspect or various implementations thereof.

In a fifth aspect, there is provided a terminal device, including a processor and a memory. The memory is used to store a computer program, and the processor is used to call and run the computer program stored in the memory to execute the method in the above first aspect or various implementations thereof.

In a sixth aspect, there is provided a network device including a processor and a memory. The memory is used to store a computer program, and the processor is used to call and run the computer program stored in the memory to execute the method in the above second aspect or various implementations thereof.

In a seventh aspect, there is provided a chip for implementing the method in any one of the first aspect to the second aspect described above or various implementations thereof.

Specifically, the chip includes: a processor, configured to call a computer program from a memory and run the computer program, so that a device equipped with the chip executes the method as described in any one of the first aspect to the second aspect described above or various implementations thereof.

In an eighth aspect, there is provided a non-transitory computer-readable storage medium for storing a computer program, where the computer program enables a computer to execute the method of any one of the first aspect to the second aspect described above or various implementations thereof.

In a ninth aspect, there is provided a computer program product, including computer program instructions, where the computer program instructions enable a computer to execute the method in any one of the first aspect to the second aspect described above or various implementations thereof.

In a tenth aspect, there is provided a computer program, which, upon being executed on a computer, enables the computer to execute the method in any one of the first aspect to the second aspect described above or various implementations thereof.

### BRIEF DESCRIPTION OF THE DRAWINGS

FIG. 1 is a schematic diagram of an architecture of a communication system provided by the embodiments of the present disclosure.

FIG. 2 is a schematic diagram of a wireless communication method provided by the embodiments of the present disclosure.

FIG. 3 is a schematic diagram of another wireless communication method provided by the embodiments of the present disclosure.

FIG. 4 is a schematic block diagram of a terminal device provided by the embodiments of the present disclosure.

FIG. 5 is a schematic block diagram of a network device provided by the embodiments of the present disclosure.

FIG. 6 is a schematic block diagram of a communication device provided by embodiments of the present disclosure.

FIG. 7 is a schematic block diagram of a chip provided by embodiments of the present disclosure.

FIG. 8 is a schematic block diagram of a communication system provided by embodiments of the present disclosure.

### DETAILED DESCRIPTION

Technical solutions in the embodiments of the present disclosure will be described below in conjunction with reference to the accompanying drawings in the embodiments of the present disclosure. Obviously, the described embodiments are merely some but not all of embodiments of the present disclosure. Based on the embodiments of the present disclosure, all other embodiments obtained by the ordinary skilled in the art belong to the protection scope of the present disclosure.

Technical solutions in the embodiments of the present disclosure may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial networks (NTN) system, a universal mobile telecommunications system (UMTS), a wireless local area network (WLAN), a wireless fidelity (WiFi), a 5th-generation (5G) communication system or other communication systems, etc.

Generally speaking, traditional communication systems support a limited quantity of connections, which is easy to implement. However, with the development of communication technology, mobile communication systems will not only support traditional communication, but also support, for example, device to device (D2D) communication, machine to machine (M2M) communication, machine type communication (MTC), vehicle to vehicle (V2V) communication, or vehicle to everything (V2X) communication, etc., and the embodiments of the present disclosure may be applied to these communication systems as well.

Optionally, the communication system in the embodiments of the present disclosure may be applied to a carrier aggregation (CA) scenario, a dual connectivity (DC) scenario, and may also be applied to a standalone (SA) network deployment scenario.

Optionally, the communication system in the embodiments of the present disclosure may be applied to an unlicensed spectrum, where the unlicensed spectrum may also be considered as a shared spectrum. Alternatively, the communication system in the embodiments of the present disclosure may be applied to a licensed spectrum, where the licensed spectrum may also be considered as an unshared spectrum.

In the embodiments of the present disclosure, various embodiments will be described in conjunction with a network device and a terminal device. The terminal device may be referred to as a user equipment (UE), an access terminal, a user unit, a user station, a mobile station, a mobile platform, a remote station, a remote terminal, a mobile device, a user terminal, a terminal, a wireless communication device, a user agent, or a user apparatus, etc.

The terminal device may be a station (ST) in a WLAN, a cellular phone, a cordless phone, a session initiation protocol (SIP) phone, a wireless local loop (WLL) station, a personal digital assistant (PDA) device, a handheld device and a computing device with wireless communication functions, or another processing device connected to a wireless modem, an in-vehicle device, a wearable device, a terminal device in a next generation communication system (e.g., an NR network), a terminal device in a future evolved public land mobile network (PLMN) network, etc.

In the embodiments of the present disclosure, the terminal device may be deployed on land including indoors or outdoors, handheld, wearable or in-vehicle; alternatively, the terminal device may be deployed on water (e.g., on a ship); alternatively, the terminal device may be deployed in the air (e.g., on an airplane, on a balloon, or on a satellite).

In the embodiments of the present disclosure, the terminal device may be a mobile phone, a pad, a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, etc.

As an example but not a limitation, in the embodiments of the present disclosure, the terminal device may be a wearable device. The wearable device may be referred to as a wearable smart device, which is a general term for a device that can be worn, into which the daily wear is intelligently designed and developed by applying wearable technologies, such as glasses, gloves, watches, clothing, and shoes, etc. The wearable device is a portable device that is worn directly on a body, or integrated into a user's clothing or accessory. The wearable device is not just a hardware device, but also achieves powerful functions through software support as well as data interaction and cloud interaction. A generalized wearable smart device includes those with full functions, large size, and entire or partial functions without relying on a smartphone (for example, a smartwatch or smart glasses, etc.), as well as, those that only focus on a certain type of application function and needs to be used in conjunction with other devices such as a smartphone (for example, a smart bracelet and smart jewelry for physical sign monitoring).

In the embodiments of the present disclosure, the network device may be a device configured to communicating with a mobile device. The network device may be an access point (AP) in WLAN, a base station (base transceiver station, BTS) in GSM or CDMA, a base station (NodeB, NB) in WCDMA, an evolutional base station (evolutional Node B, eNB or eNodeB) in LTE, a relay station or an access point, an in-vehicle device, a wearable device, a network device (gNB) in an NR network, a network device in a future evolutional PLMN network, or a network device in an NTN network, etc.

As an example but not limitation, in the embodiments of the present disclosure, the network device may have mobile characteristics. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may also be a base station deployed on land, water, or other places.

In the embodiments of the present disclosure, the network device may provide services for a cell, and the terminal device communicates with the network device through a transmission resource (e.g., a frequency-domain resource, or a spectrum resource) used by the cell. The cell may be a cell corresponding to the network device (e.g., a base station). The cell may belong to a macro base station, or may belong to a base station corresponding to a small cell. The small cell herein may include a metro cell, a micro cell, a pico cell, a femto cell, etc. These small cells have characteristics of small coverage range and low transmission power, and are applicable for providing data transmission services with a high speed.

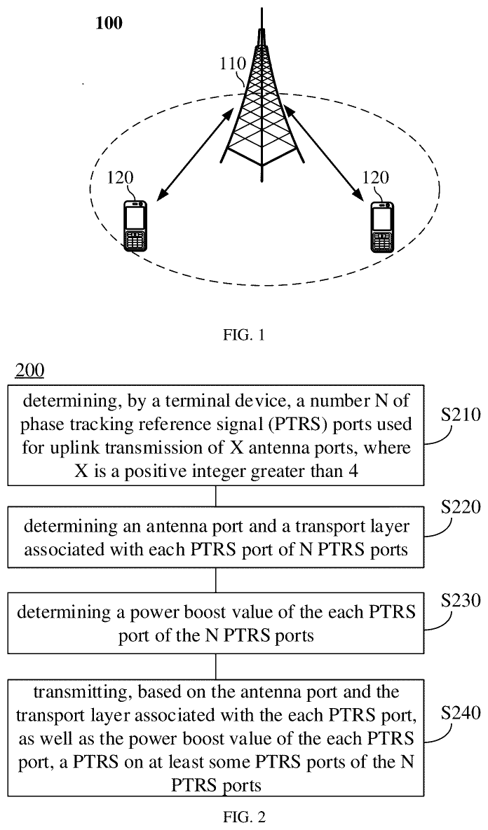

For example, a communication system 100 applied in the embodiments of the present disclosure is shown in FIG. 1. The communication system 100 may include a network device 110, and the network device 110 may be a device that communicates with terminal devices 120 (also referred to as communication terminals or terminals). The network device 110 may provide communication coverage for a specific geographical area and may communicate with terminal devices located within the coverage area.

FIG. 1 exemplarily shows a network device and two terminal devices. Optionally, the communication system 100 may include a plurality of network devices, and another number of terminal devices may be included within the coverage of each network device, which are not limited in the embodiments of the present disclosure.

Optionally, the communication system 100 may further include a network controller, a mobility management entity, and other network entities, which are not limited in the embodiments of the present disclosure.

It should be understood that a device with communication functions in the network/system in the embodiments of the present disclosure may be referred to as a communication device. Taking the communication system 100 shown in FIG. 1 as an example, the communication device may include a network device 110 and terminal devices 120 with communication functions. The network device 110 and the terminal devices 120 may be the specific devices described above, which will not be repeated herein; the communication device may further include other devices, such as a network controller, a mobility management entity, and other network entities, in the communication system 100, which are not limited in the embodiments of the present disclosure.

It should be understood that the terms “system” and “network” or variations thereof are often used interchangeably herein. The term “and/or” herein is only a description of an association relationship of associated objects, and indicates that there may be three kinds of relationships. For example, “A and/or B” may represent three cases: A exists alone, both A and B exist, and B exists alone. In addition, the character “/” herein generally indicates that the associated objects before and after this character are in an “or” relationship.

It should be understood that “indicate” or variations thereof mentioned in embodiments of the present disclosure may be a direct indication, an indirect indication, or mean that there is an association relationship. For example, A indicating B may mean that A directly indicates B, for example, B may be acquired through A; alternatively, A indicating B may mean that A indirectly indicates B, for example, A indicates C, and B may be acquired through C; alternatively, A indicating B may mean that there is an association relationship between A and B.

In the description of the embodiments of the present disclosure, the term “corresponding” or variations thereof may indicate a direct or indirect corresponding relationship between two items, or an association relationship between two items, or a relationship of indicating and being indicated, or a relationship of configuring and being configured, etc.

In the embodiments of the present disclosure, the term “predefinition” or variations thereof may be achieved by pre-saving corresponding codes, tables or other manners that may be used to indicate relevant information in devices (e.g., including a terminal device and a network device), and the specific implementation thereof is not limited in the present disclosure. For example, predefinition may refer to what is defined in a protocol.

In the embodiments of the present disclosure, the term “protocol” may refer to a standard protocol in the field of communications, which may include, for example, an LTE protocol, an NR protocol, a Wi-Fi protocol, the evolution of protocols related to other communication systems related thereto, and related protocols applied in a future communication system, and types of specific protocols will not be limited in the present disclosure.

In some scenarios, a terminal may support uplink transmission of up to 4 antenna ports. To support uplink transmission of FR2, the terminal may be configured with 1 to 2 phase tracking reference signal (PTRS) port(s), and each PTRS port is associated with a different transport layer or a different demodulation reference signal (DMRS), and a PTRS may be configured for phase tracking and adjustment of an associated transport layer or DMRS, thereby ensuring performance of a channel estimation of DMRS and data demodulation. For a full coherent codebook, all transport layers/DMRS ports are associated with a same PTRS port (in this case, the network device will only be configured with one PTRS port). For the case of configuring a partial-coherent codebook and a non-coherent codebook, a number of the PTRS ports actually transmitted depends on a number of transport layers and an indication of the transmitted precoding matrix indicator (TPMI). A physical uplink shared channel (PUSCH) antenna ports 1000 and 1002, as well as a DMRS (transport layer) transmitted on these two ports are associated with PTRS port 0 (that is, a phase estimation result on the PTRS port may be used for the PUSCH and the DMRS transmitted on these two antenna ports). The PUSCH antenna ports 1001 and 1003 and a DMRS (transport layer) transmitted on these two ports are associated with PTRS port 1. If there are a plurality of DMRS ports transmitted on an antenna port, which DMRS port of the plurality of DMRS ports being actually associated with a corresponding PTRS port needs to be determined according to indication information in downlink control information (DCI). The PTRS port and an associated DMRS port use a same sequence, frequency domain resource and precoding matrix.

In addition, since a PTRS port may be associated with a plurality of transport layers, in order to ensure that the power on different orthogonal frequency-division multiplexing (OFDM) symbols is consistent, power of PTRS needs to be adjusted according to the number of configured transport layers. Specifically, based on the difference of the number of transport layers, a coherent configuration of the codebook and the transmission scheme (based on codebook transmission or non-codebook transmission), power boosting of a PTRS relative to an associated DMRS port may be obtained from Table 1. The specific power boosting scheme to be adopted is configured by the network device. Herein, a power boosting value is a boosting value of the transmit power of one PTRS port relative to a DMRS port or a transport layer associated with the PTRS port. Qp is a number of PTRS ports currently configured (1 or 2), coherent configuration of the codebook (full coherent codebook/partial-coherent codebook/non-coherent) and the transmission scheme configuration (codebook based or non-codebook based) are obtained by a high-level signaling.

TABLE 1

| | Number of transport layers of PUSCH (n_{layer}^{PUSCH}) | | | | | | | |
|---|---|---|---|---|---|---|---|---|
| | | 2 | | | | | | |
| | | | partial- | | | 4 | | |
| | | | coherent/non- | 3 | | | | non- |
| | | | coherent | | partial-coherent/ | | | coherent |
| | | | codebook | | non-coherent | | | codebook |
| power | 1 | full | and | full | codebook | full | partial- | and |
| boosting | all | coherent | non- | coherent | and non- | coherent | coherent | non- |
| configuration | situations | codebook | codebook | codebook | codebook | codebook | codebook | codebook |
| 00 | 0 | 3 | 3Qₚ − 3 | 4.77 | 3Qₚ − 3 | 6 | 3Qₚ | 3Qₚ − 3 |
| 01 | 0 | 3 | 3 | 4.77 | 4.77 | 6 | 6 | 6 |

| | |
|---|---|
| 10 | Reserved |
| 11 | Reserved |

In related technologies, uplink transmission supports up to 4 PUSCH antenna ports. At the same time, in FR2, the network device may be configured at most 2 PTRS ports to be associated with the PUSCH antenna port.

In some scenarios, some advanced terminals may be configured with more transmission links or radio frequency channels, and at this time, the advanced terminals may support more PUSCH antenna ports, e.g., 8 PUSCH antenna ports, to further improve uplink transmission performance. In this case, how to transmit the PTRS to support more PUSCH antenna ports and thus improve the uplink transmission performance is an urgent problem that needs to be solved.

To facilitate an understanding of the technical solutions in the embodiments of the present disclosure, the technical solutions of the present disclosure will be described in detail below through specific embodiments. The following related arts, as optional solutions, may be arbitrarily combined with the technical solutions in the embodiments of the present disclosure, and those combined solutions all fall within the protection scope of the embodiments of the present disclosure. The embodiments of the present disclosure include at least part of the following contents.

The embodiments of the present disclosure provides a wireless communication method, which includes:
determining, by a terminal device, a number N of phase tracking reference signal (PTRS) ports used for uplink transmission of X antenna ports, where X is a positive integer greater than 4;
determining an antenna port and a transport layer associated with each PTRS port of N PTRS ports;
determining a power boosting value of the each PTRS port of the N PTRS ports; and
transmitting, based on the antenna port and the transport layer associated with the each PTRS port, as well as the power boosting value of the each PTRS port, a PTRS on at least some PTRS ports of the N PTRS ports.

In some embodiments, determining, by the terminal device, the number N of the PTRS ports used for the uplink transmission of the X antenna ports, includes:
determining, based on a number K of antenna port groups contained in the X antenna ports, the number N of the PTRS ports.

In some embodiments, the number N of the PTRS ports is less than or equal to K.

In some embodiments, the number N of the PTRS ports is equal to K in a case where a partial-coherent codebook is configured or a non-coherent codebook is configured.

In some embodiments, the number N of the PTRS ports is equal to K, in a case where a non-coherent codebook is configured;
the number N of the PTRS ports is configured by a network device and N is less than or equal to K, in a case where a partial-coherent codebook is configured; and
the number N of the PTRS ports is 1, in a case where a full coherent codebook is configured.

In some embodiments, determining the antenna port and the transport layer associated with the each PTRS port of the N PTRS ports includes:
determining, based on a number K of antenna port groups contained in the X antenna ports, the antenna port and the transport layer associated with the each PTRS port in a case where a partial-coherent codebook is configured.

In some embodiments, determining the antenna port and the transport layer associated with the each PTRS port of the N PTRS ports includes:
determining, based on a number K of antenna port groups contained in the X antenna ports, the antenna port and the transport layer associated with the each PTRS port in a case where a partial-coherent codebook is configured.

In some embodiments, X=8, a PTRS port 0 is associated with antenna ports {0, 1, 4, 5} and a PTRS port 1 is associated with antenna ports {2, 3, 6, 7} in a case where K=2; and
a PTRS port 0 is associated with antenna ports {0, 4}, a PTRS port 1 is associated with antenna ports {1, 5}, a PTRS port 2 is associated with antenna ports {2, 6} and a PTRS port 3 is associated with antenna ports {3, 7} in a case where K=4.

In some embodiments, determining the antenna port and the transport layer associated with the each PTRS port of the N PTRS ports includes:
determining an antenna port group of antenna port groups contained in the X antenna ports associated with the each PTRS port; where an antenna port contained in each antenna port group is preconfigured by a network device.

In some embodiments, determining the antenna port and the transport layer associated with the each PTRS port of the N PTRS ports includes:
determining that a PTRS port 0 is associated with antenna ports {0, 1, 4, 5} and a PTRS port 1 is associated with antenna ports {2, 3, 6, 7} in a case where the number N of the PTRS ports is equal to 2; and
determining that a PTRS port 0 is associated with antenna ports {0, 4}, a PTRS port 1 is associated with antenna ports {1, 5}, a PTRS port 2 is associated with antenna ports {2, 6}, and a PTRS port 3 is associated with antenna ports {3, 7} in a case where the number N of the PTRS ports is equal to 4.

In some embodiments, determining the antenna port and the transport layer associated with the each PTRS port of the N PTRS ports includes:
determining that a first PTRS port is associated with a first antenna port set for transmitting a first transport layer, and a second PTRS port is associated with a second antenna port set for transmitting a second transport layer, where the first transport layer and the second transport layer are different PUSCH transport layers, the first antenna port set and the second antenna port set are different, and the first PTRS port and the second PTRS port are different.

In some embodiments, the method further includes:
determining, by the terminal device based on the antenna port associated with the each PTRS port and transmitted precoding matrix indicator (TPMI) indication information in downlink control information (DCI), a number M of PTRS ports actually used for the uplink transmission of the X antenna ports.

In some embodiments, the number M of PTRS ports actually used for the uplink transmission of the X antenna ports is a number of all PTRS ports associated with an antenna port corresponding to a non-zero element in a precoding matrix indicated by the TPMI indication information.

In some embodiments, determining the antenna port and the transport layer associated with the each PTRS port of the N PTRS ports includes:
determining, by the terminal device based on demodulation reference signal (DMRS)-PTRS association indication information in DCI, a transport layer associated with the PTRS port from a first transport layer set, where the first transport layer set includes transport layers transmitted on an antenna port associated with the PTRS port.

In some embodiments, the method further includes:
determining, by the terminal device based on DMRS-PTRS association indication information in DCI, a DMRS port associated with the PTRS port from a first DMRS port set, where the first DMRS port sets includes DMRS ports transmitted on an antenna port associated with the PTRS port.

In some embodiments, determining the power boosting value of the each PTRS port of the N PTRS ports includes:
determining, based on a number K of antenna port groups contained in the X antenna ports and a number of transport layers of a physical uplink shared channel (PUSCH) to be transmitted, the power boosting value of the each PTRS port, in a case where a partial-coherent codebook is configured.

In some embodiments, the power boosting value is 10*lg (N) dB in a case where the number of transport layers of the PUSCH is 2 or 3;
the power boosting value is 10*lg (4N/K) dB in a case where the number of transport layers of the PUSCH is 4 or 5;
the power boosting value is 10*lg (N*└6/K┘) in a case where the number of transport layers of the PUSCH is 6 or 7;
the power boosting value is 10*lg 10*lg (8N/K) dB in a case where the number of transport layers of the PUSCH is 8.

In some embodiments, the power boosting value is 3N−3+10*lg (└L/2┘) dB in a case where K=2 and the number of transport layers of the PUSCH is 2 to 8, where L is the number of transport layers of the PUSCH;
the power boosting value is 3N−3+3*└L/8┘ in a case where K=4 and the number of transport layers of the PUSCH is 2 to 8, where L is the number of transport layers of the PUSCH.

In some embodiments, determining the power boosting value of the each PTRS port of the N PTRS ports includes:
determining that the power boosting value of the each PTRS port is 10*lg (N) dB in a case where a non-coherent codebook is configured.

In some embodiments, a number K of antenna port groups contained in the X antenna ports is configured by a network device through a high-layer signaling.

In some embodiments, the method further includes:
reporting, by the terminal device, a number K of antenna port groups contained in the X antenna ports to a network device, where K is used to determine at least one of the number N of the PTRS ports, the antenna port and the transport layer associated with the each PTRS port, or the power boosting value of the each PTRS port.

The embodiments of the present disclosure further provides a wireless communication method, which includes:
determining, by a network device, a number N of phase tracking reference signal (PTRS) ports used for uplink transmission of X antenna ports, where X is an integer greater than 4;
determining an antenna port and a transport layer associated with each PTRS port of N PTRS ports;
receiving, based on the number N of the PTRS ports, a PTRS on at least some PTRS ports of the N PTRS ports; and
performing, based on a phase measurement result of the PTRS, a channel estimation of a demodulation reference signal (DMRS) or a phase adjustment of a transport layer associated with the N PTRS ports.

In some embodiments, determining, by the network device, the number N of the PTRS ports used for the uplink transmission of the X antenna ports, includes:
determining, based on a number K of antenna port groups contained in the X antenna ports, the number N of the PTRS ports.

In some embodiments, the number N of the PTRS ports is less than or equal to K.

In some embodiments, the number N of the PTRS ports is equal to K, in a case where a partial-coherent codebook is configured or a non-coherent codebook is configured.

In some embodiments, the number N of the PTRS ports is equal to K, in a case where a non-coherent codebook is configured;
the number N of the PTRS ports is less than or equal to K, in a case where a partial-coherent codebook is configured; and
the number N of the PTRS ports is 1, in a case where a full coherent codebook is configured.

In some embodiments, determining the antenna port and the transport layer associated with the each PTRS port of the N PTRS ports includes:
determining, based on a number K of antenna port groups contained in the X antenna ports, the antenna port and the transport layer associated with the each PTRS port in a case where a partial-coherent codebook is configured.

In some embodiments, X=8, a PTRS port 0 is associated with antenna ports {0, 1, 4, 5} and a PTRS port 1 is associated with antenna ports {2, 3, 6, 7} in a case where K=2; and
a PTRS port 0 is associated with antenna ports {0, 4}, a PTRS port 1 is associated with antenna ports {1, 5}, a PTRS port 2 is associated with antenna ports {2, 6} and a PTRS port 3 is associated with antenna ports {3, 7} in a case where K=4.

In some embodiments, determining the antenna port and the transport layer associated with the each PTRS port of the N PTRS ports includes:
determining an antenna port group of antenna port groups contained in the X antenna ports associated with the each PTRS port; where an antenna port contained in each antenna port group is preconfigured by a network device.

In some embodiments, determining the antenna port and the transport layer associated with the each PTRS port of the N PTRS ports includes:
determining that a PTRS port 0 is associated with antenna ports {0, 1, 4, 5} and a PTRS port 1 is associated with antenna ports {2, 3, 6, 7}, in a case where the number N of the PTRS ports is equal to 2; and
determining that a PTRS port 0 is associated with antenna ports {0, 4}, a PTRS port 1 is associated with antenna ports {1, 5}, a PTRS port 2 is associated with antenna ports {2, 6}, and a PTRS port 3 is associated with antenna ports {3, 7}, in a case where the number N of the PTRS ports is equal to 4.

In some embodiments, determining the antenna port and the transport layer associated with the each PTRS port of the N PTRS ports includes:
determining that a first PTRS port is associated with a first antenna port set for transmitting a first transport layer, and a second PTRS port is associated with a second antenna port set for transmitting a second transport layer, where the first transport layer and the second transport layer are different, the first antenna port set and the second antenna port set are different, and the first PTRS port and the second PTRS port are different.

In some embodiments, the method further includes:
determining, based on the antenna port associated with the each PTRS port and transmitted precoding matrix indicator (TPMI) indication information in downlink control information (DCI), a number M of PTRS ports actually used for the uplink transmission of the X antenna ports.

In some embodiments, the number M of PTRS ports actually used for the uplink transmission of the X antenna ports is a number of all PTRS ports associated with an antenna port corresponding to a non-zero element in a precoding matrix indicated by the TPMI indication information.

In some embodiments, determining the antenna port and the transport layer associated with the each PTRS port of the N PTRS ports includes:
determining, based on demodulation reference signal (DMRS)-PTRS association indication information in DCI, a transport layer associated with the PTRS port from a first transport layer set, where the first transport layer set includes transport layers transmitted on an antenna port associated with the PTRS port.

In some embodiments, the method further includes:
determining, based on DMRS-PTRS association indication information in DCI, a DMRS port associated with the PTRS port from a first DMRS port set, where the first DMRS port set includes DMRS ports transmitted on an antenna port associated with the PTRS port.

In some embodiments, a number K of antenna port groups contained in the X antenna ports is configured by a network device through a high-layer signaling.

In some embodiments, the method further includes:
receiving, by the network device, a number K of antenna port groups contained in the X antenna ports reported by a terminal device, where K is used to determine the number N of the PTRS ports, and/or the antenna port and the transport layer associated with the each PTRS port.

FIG. 2 is a schematic flow chart of a wireless communication method 200 provided by the embodiments of the present disclosure. The method 200 may be executed by a terminal device in the communication system shown in FIG. 1. As shown in FIG. 2, the method 200 includes S210 to S240.

In S210, the terminal device determines a number N of phase tracking reference signal (PTRS) ports used for uplink transmission of X antenna ports.

In S220, an antenna port and a transport layer associated with each PTRS port of N PTRS ports is determined.

In S230, a power boosting value of the each PTRS port of the N PTRS ports is determined.

In S240, a PTRS is transmitted on at least some PTRS ports of the N PTRS ports based on the antenna port and the transport layer associated with the each PTRS port, as well as the power boosting value of the each PTRS port.

In some embodiments, X is an integer greater than 4, for example, X=6, 8, 12, 16, or the like. The following description takes X=8 as an example, but the present disclosure is not limited thereto.

In some embodiments, the antenna port is also called a PUSCH antenna port, and the antenna port is configured for PUSCH transmission.

In some embodiments, a PTRS port may refer to a port configured for the PTRS transmission.

It should be noted that, in the embodiments of the present disclosure, the transmission of the PTRS port may refer to the transmission of a PTRS signal through the PTRS port, which are equivalent and may be replaced with each other. Similarly, the transmission of the DMRS port may refer to the transmission of a DMRS signal through the DMRS port, which is equivalent and may be replaced with each other; the transmission of the antenna port may refer to the transmission of a PUSCH through the antenna port, which is equivalent and may be replaced with each other.

In some embodiments, S220 may be replaced by:
determining an antenna port and a DMRS port associated with the each PTRS port of the N PTRS ports.

Since the transport layer associated with the PTRS port and the DMRS port associated with the PTRS port have a mapping relationship, the terminal device determines the transport layer associated with the each PTRS port, which is equivalent to determining the DMRS port associated with the each PTRS port.

In the following, in combination with Embodiment 1, a method for determining the number N of PTRS ports used for the uplink transmission of X antenna ports is described.

Embodiment 1: the determination of the number N of PTRS ports used for the uplink transmission of X antenna ports.

Embodiment 1-1: the terminal device determines, based on the number K of antenna port groups contained in the X antenna ports, the number N of the PTRS ports.

In some embodiments, the number N of the PTRS ports is less than or equal to K.

In some embodiments, the terminal device may determine the number N of the PTRS ports based on the number K of antenna port groups contained in the X antenna ports and the coherent configuration of the codebook.

Optionally, the coherent configuration of the codebook may include a full coherent codebook, a partial-coherent codebook, and a non-coherent codebook.

### Manner 1:

the number N of the PTRS ports is equal to K, in a case where a partial-coherent codebook is configured; or,
the number N of the PTRS ports is equal to K, in a case where a non-coherent codebook is configured.

In an implementation, the terminal device may report the number of antenna port groups to the network device. For example, the number of the antenna port groups may be carried in UE capability information to be reported to the network device, and the number of PTRS ports may be configured by the network device. In a case where the non-coherent codebook is configured or the partial-coherent codebook is configured, the network device should ensure that the number of the antenna port groups and the number of PTRS ports are equal when the number of PTRS ports is configured, that is, a number of antenna port groups currently configured by the terminal device is the same as a number of PTRS ports configured by the network device. However, there is no such requirement upon configuring the full coherent codebook.

In another implementation, the terminal device may report the number of antenna port groups to the network device. For example, the number of the antenna port groups may be carried in UE capability information to be reported to the network device. In a case where the non-coherent codebook is configured or the partial-coherent codebook is configured, the terminal device directly determines the number N of the PTRS ports based on the number of antenna port groups reported in the UE capability information, while there is no need for the network device to configure the number of PTRS ports. When the full coherent codebook is configured, it is necessary to assume that N is fixed to 1, regardless of UE capability.

### Manner 2:

the number N of the PTRS ports is equal to K, in a case where a non-coherent codebook is configured; and
the number N of the PTRS ports is less than or equal to K, in a case where a partial-coherent codebook is configured; and
the number N of the PTRS ports is 1, in a case where a full coherent codebook is configured.

In some embodiments, in a case where the partial-coherent codebook is configured, the number N of the PTRS ports may be configured by the network device.

For example, in a case where X=8 and the network device configures a non-coherent codebook for the terminal device, N=K=8.

For another example, in a case where X=8 and the network device configures a partial-coherent codebook for the terminal device, if K=4, then N may be one of 1, 2, or 4, and the specific value of N may be configured by the network device; if K=2, then N may be one of 1 or 2, and the specific value of N may be configured by the network device.

For another example, in a case where X=8, and the network device configures a full coherent codebook for the terminal device, the number N of the PTRS ports is 1, which does not require to be configured by the network device.

### Manner 3:

the number N of the PTRS ports is less than or equal to K, in a case where a non-coherent codebook is configured;
the number N of the PTRS ports is equal to K, in a case where a partial-coherent codebook is configured;
the number N of the PTRS ports is 1, in a case where a full coherent codebook is configured.

In some embodiments, in a case where the non-coherent codebook is configured, the number N of the PTRS ports may be configured by the network device.

For example, in a case where X=8, and the network device configures a non-coherent codebook for the terminal device, then K=8, and the value of N may be one of 1, 2, 4, or 8, and the specific value of N may be configured by the network device.

For another example, in a case where X=8 and the network device configures a partial-coherent codebook for the terminal device, N=K=4 or N=K=2.

Optionally, in the embodiments of the present disclosure, the codebook being a full coherent codebook, a partial-coherent codebook, or a non-coherent codebook (i.e., a coherent configuration of the codebook) is configured by the network device through a high-layer signaling. For example, the high-layer signaling may include but is not limited to a radio resource control (RRC) signaling.

In an implementation, the number K of antenna port groups included in the X antenna ports is preconfigured for the terminal device by the network device. For example, the network device notifies the terminal device of the number K in advance through the high-layer signaling. That is, the network device and the terminal device have the same understanding of the number K of the antenna port groups. Furthermore, in a case where K takes different values, the antenna ports included in the antenna port group may be pre-agreed between the network device and the terminal device, or may be configured by the network device to the terminal device.

For example, taking X=8 as an example, in a case where K=1, one antenna port group includes all antenna ports; in a case where K=2, an antenna port group 0 includes antenna ports {0, 1, 4, 5}, and an antenna port group 1 includes antenna ports {2, 3, 6, 7}; in a case where K=4, an antenna port group 0 includes antenna ports {0, 4}, an antenna port group 1 includes antenna ports {1, 5}, an antenna port group 2 includes antenna ports {2, 6}, and an antenna port group 3 includes antenna ports {3, 7}. In a case where K=8, an antenna port group k includes antenna port k, where the value of k is 0, 1, . . . , 7.

In another implementation, the terminal device reports the number K of antenna port groups contained in the X antenna ports to a network device, where K is used to determine at least one of the number N of the PTRS ports, the antenna port and the transport layer associated with the each PTRS port, or the power boosting value of the each PTRS port. That is, the network device and the terminal device have the same understanding of the number K of the antenna port groups.

Embodiment 1-2: the number N of the PTRS ports is configured by the network device, where N is less than or equal to K.

For example, the terminal device may report the capability related to the PTRS port to the network device, and the network device may determine the number N of the PTRS ports based on the capabilities related to PTRS port reported by the terminal device.

Optionally, the capability related to PTRS port may include the number of PTRS ports expected (or required) or supported by the terminal device, and/or the number K of antenna port groups included in the X antenna ports.

It should be noted that the number N of PTRS ports herein may be a maximum number of PTRS ports used for the uplink transmission of X antenna ports. The number of PTRS ports actually used needs to be determined based on antenna ports actually used to transmit data (e.g., PUSCH), for example, based on TPMI indication information.

Therefore, in the embodiments of the present disclosure, in a case where uplink 8-antenna port transmission is supported, the terminal device may determine the appropriate number N of PTRS ports based on the number K of the antenna port groups included in the X antenna ports, so that different numbers of PTRS ports may be determined for different antenna port grouping manners, thereby ensuring the phase tracking performance of the uplink 8-antenna port transmission under different antenna arrays.

In the following, in combination with embodiment 2, a method for determining the antenna port and the transport layer associated with the each PTRS port is described.

Embodiment 2: the determination of the antenna port and the transport layer associated with the PTRS port.

In some embodiments, the terminal device may determine the antenna port and the transport layer associated with the each PTRS port based on the coherent configuration of the codebook.

For example, in a case where the network device configures a full coherent codebook for the terminal device, the network device will only configure one PTRS port, where the one PTRS port will be associated with all antenna ports.

Embodiment 2-1: the antenna port associated with the each PTRS port is determined, based on the number K of the antenna port groups contained in the X antenna ports.

In some embodiments, the terminal device may determine the antenna port associated with the each PTRS port based on the number K of the antenna port groups contained in the X antenna ports and the coherent configuration of the codebook.

For example, in a case where the partial-coherent codebook is configured, the terminal device determines the antenna port associated with the each PTRS port based on the number K of the antenna port groups contained in the X antenna ports.

In some specific embodiments, in a case where the partial-coherent codebook is configured, the terminal device may determine the antenna port associated with the each PTRS port based on the number K of antenna port groups contained in the X antenna ports and a first association relationship. The first association relationship includes a relationship between the PTRS port and the antenna port in a case where K takes at least one value.

Taking X=8 as an example, the first association relationship may include at least one of association relationships:
a PTRS port 0 is associated with antenna ports {0, 1, 4, 5} and a PTRS port 1 is associated with antenna ports {2, 3, 6, 7} in a case where K=2;
a PTRS port 0 is associated with antenna ports {0, 2, 4, 6} and a PTRS port 1 is associated with antenna ports {1, 3, 5, 7} in a case where K=2; or
a PTRS port 0 is associated with antenna ports {0, 4}, a PTRS port 1 is associated with antenna ports {1, 5}, a PTRS port 2 is associated with antenna ports {2, 6} and a PTRS port 3 is associated with antenna ports {3, 7} in a case where K=4.

Embodiment 2-2: the antenna port associated with the each PTRS port is determined based on configuration of the antenna port group.

For example, it is determined that each PTRS port is associated with one of the antenna port groups contained in the X antenna ports.

That is, antenna ports associated with one PTRS port include all antenna ports in one antenna port group.

Optionally, antenna ports contained in each antenna port group may be preconfigured by the network device. For example, in a case where X=8, the network device may be configured with 2 or 4 antenna port groups.

Embodiment 2-3: the antenna port associated with the each PTRS port is determined based on the number N of PTRS ports.

In some embodiments, the terminal device may determine the antenna port associated with the each PTRS port based on the number N of PTRS ports and a second association relationship. The second association relationship includes a relationship between the PTRS port and the antenna port in a case where N takes at least one value.

Taking X=8 as an example, the second association relationship may include at least one of association relationships:
in a case where the number N of the PTRS ports is equal to 1, the PTRS port is associated with all antenna ports;
in a case where the number N of the PTRS ports is equal to 2, a PTRS port 0 is associated with antenna ports {0, 1, 4, 5} and a PTRS port 1 is associated with antenna ports {2, 3, 6, 7};
in a case where the number N of the PTRS ports is equal to 4, a PTRS port 0 is associated with antenna ports {0, 4}, a PTRS port 1 is associated with antenna ports {1, 5}, a PTRS port 2 is associated with antenna ports {2, 6}, and a PTRS port 3 is associated with antenna ports {3, 7}.

Embodiment 2-4: the antenna port associated with the each PTRS port is determined based on the transport layer transmitted on the antenna port.

In some embodiments, the terminal device may determine that one PTRS port is associated with antenna ports that transmit the same transport layer. That is, antenna ports associated with the PTRS port are used to transmit the same transport layer.

For example, it is determined that a first PTRS port is associated with a first antenna port set, and a second PTRS port is associated with a second antenna port set, where antenna ports in the first antenna port set are all used to transmit a first transport layer, and antenna ports in the second antenna port set are all used to transmit a second transport layer, the first transport layer and the second transport layer are different PUSCH transport layers, the first antenna port set and the second antenna port set are different, and the first PTRS port is different from the second PTRS port.

That is, an antenna port associated with the PTRS port needs to be determined based on an antenna port actually used by the transport layer, for example, based on TPMI indication information.

For example, assuming that the precoding matrix indicated by the TPMI indication information is:

$$[ \begin{matrix}1 & 0 \\ 0 & 1 \\ 0 & 0 \\ 0 & 0 \\ 1 & 0 \\ 0 & 1 \\ 0 & 0 \\ 0 & 0\end{matrix} ] ,$$

then antenna ports 0 and 4 for transmitting the first transport layer are associated with a PTRS port 0, and antenna ports 1 and 5 for transmitting the second transport layer are associated with a PTRS port 1.

For another example, assuming that the precoding matrix indicated by the TPMI indication information is:

$$[ \begin{matrix}1 & 0 \\ 1 & 0 \\ 0 & 1 \\ 0 & 1 \\ - 1 & 0 \\ 1 & 0 \\ 0 & 1 \\ 0 & - 1\end{matrix} ] ,$$

then antenna ports {0, 1, 4, 5} for transmitting the first transport layer are associated with a PTRS port 0, and antenna ports {2, 3, 6, 7} for transmitting the second transport layer are associated with a PTRS port 1.

For another example, assuming that the precoding matrix indicated by the TPMI indication information is:

$$[ \begin{matrix}1 & 0 \\ 0 & 1 \\ 1 & 0 \\ 0 & 1 \\ - 1 & 0 \\ 0 & 1 \\ - 1 & 0 \\ 0 & - 1\end{matrix} ] ,$$

then antenna ports {0, 2, 4, 6} for transmitting the first transport layer are associated with a PTRS port 0, and antenna ports {1, 3, 5, 7} for transmitting the second transport layer are associated with a PTRS port 1.

Therefore, in embodiments 2 to 4, an association relationship between the antenna port and the PTRS port is not fixed, and is determined based on the antenna port actually used for transport layer transmission in the precoding matrix indicated by the TPMI indication information.

In some embodiments of the present disclosure, the antenna port associated with the each PTRS port may be used to determine the number M of PTRS ports actually used for the uplink transmission of X antenna ports and/or the DMRS port associated with the PTRS port.

In some embodiments, the method 200 further includes:
determining, based on the antenna port associated with the each PTRS port and TPMI indication information in DCI, a number M of PTRS ports actually used for the uplink transmission of X antenna ports, where the TPMI indication information is used to indicate a precoding matrix (i.e., a codeword in a predefined codebook).

For example, a number of all PTRS ports associated with the antenna ports corresponding to a non-zero element in the precoding matrix indicated by the TPMI indication information is determined as a number M of PTRS ports actually used for the uplink transmission of X antenna ports.

In some embodiments, the number M of PTRS ports actually used for the uplink transmission of X antenna ports may be used to determine the PTRS actually transmitted, that is, the terminal device actually only needs to transmit M PTRS ports instead of N PTRS ports.

In some embodiments, the number M may be used to determine the DMRS ports associated with the PTRS, that is, the terminal device only needs to determine the DMRS ports associated with the M PTRS ports actually transmitted, and does not need to determine the DMRS ports associated with the N PTRS ports. The specific determination manner is described below.

In some embodiments, the number M may be used to determine the power boosting value of the PTRS port. For example, N in the table or formula exemplified below may be replaced by the number M.

As an example, it is assumed that the precoding matrix indicated by the TPMI indication information is:

$$[ \begin{matrix}1 & 0 \\ 1 & 0 \\ 0 & 1 \\ 0 & 1 \\ - 1 & 0 \\ 1 & 0 \\ 0 & 1 \\ 0 & - 1\end{matrix} ] ,$$

and the antenna ports {0, 1, 4, 5} are associated with a PTRS port 0, and antenna ports {2, 3, 6, 7} are associated with a PTRS port 1, then since the above 8 antenna ports are all used to transmit data (the corresponding rows contain non-zero elements), the actual number M of PTRS ports is equal to 2.

As another example, it is assumed that the precoding matrix indicated by the TPMI indication information is:

$$[ \begin{matrix}1 \\ 1 \\ 0 \\ 0 \\ - 1 \\ 1 \\ 0 \\ 0\end{matrix} ] ,$$

and the antenna ports {0, 1, 4, 5} are associated with a PTRS port 0, and the antenna ports {2, 3, 6, 7} are associated with a PTRS port 1, then since only the antenna ports {0, 1, 4, 5} are used to transmit data (the corresponding rows contain non-zero elements), at this time, the actual number M of PTRS ports is equal to 1, that is, only PTRS port 0 is actually used for transmission.

Embodiment 2-5: the transport layer associated with the PTRS port is determined based on the transport layer transmitted on the antenna port associated with the PTRS port.

In some embodiments, the S220 includes:
determining, based on DMRS-PTRS association indication information in DCI, a transport layer associated with a PTRS port from a first transport layer set, where the first transport layer set includes transport layers transmitted on an antenna port associated with the PTRS port.

The DMRS-PTRS association indication information is used to indicate an association relationship between the DMRS port and the PTRS port.

That is, in a case where a plurality of transport layers are transmitted on the antenna port associated with a PTRS port, that is, in a case where the first transport layer set includes the plurality of transport layers, the terminal device may determine the target transport layer associated with the PTRS port from the plurality of transport layers based on the DMRS-PTRS association indication information.

Optionally, if at most two transport layers are transmitted on an antenna port associated with the first PTRS port, 1-bit DMRS-PTRS association indication information may be used to indicate a target transport layer associated with the first PTRS port and in the two transport layers.

Optionally, if at most four transport layers are transmitted on an antenna port associated with the first PTRS port, 2-bit DMRS-PTRS association indication information may be used to indicate a target transport layer associated with the first PTRS port and in the four transport layers.

Optionally, if at most eight transport layers are transmitted on an antenna port associated with the first PTRS port, 3-bit DMRS-PTRS association indication information may be used to indicate a target transport layer associated with the first PTRS port and in the eight transport layers.

In some embodiments, the method 200 further includes:
determining, based on DMRS-PTRS association indication information in DCI, a DMRS port associated with the PTRS port from a first DMRS port set, where the first DMRS port set includes DMRS ports transmitted on an antenna port associated with the PTRS port.

That is, in a case where a plurality of DMRS ports are transmitted on the antenna port associated with a PTRS port, that is, in a case where the first DMRS port set includes a plurality of DMRS ports, the terminal device may determine the target DMRS port associated with the PTRS port in the plurality of DMRS ports based on the DMRS-PTRS association indication information.

Optionally, if at most two DMRS ports are transmitted on an antenna port associated with the first PTRS port, 1-bit DMRS-PTRS association indication information may be used to indicate a target DMRS port associated with the first PTRS port and in the two DMRS ports.

Optionally, if at most four DMRS ports are transmitted on an antenna port associated with the first PTRS port, 2-bit DMRS-PTRS association indication information may be used to indicate a target DMRS port associated with the first PTRS port and in the four DMRS ports.

Optionally, if at most eight DMRS ports are transmitted on an antenna port associated with the first PTRS port, 3-bit DMRS-PTRS association indication information may be used to indicate a target DMRS port associated with the first PTRS port and in the eight DMRS ports.

In some embodiments, if one PTRS port is associated with one transport layer, the PTRS port is also associated with a DMRS port used by the transport layer. Further, the DMRS port of the transport layer is used to transmit the PTRS port, that is, the PTRS port and the associated DMRS port use the same sequence, frequency domain position, precoding matrix and beam. That is, the signal transmitted on the PTRS port and the signal transmission manner are the same as those of the associated DMRS port, so that the receiving end may perform joint channel estimation or phase estimation by using the signals on the associated DMRS port and the PTRS port.

As an example, it is assumed that the precoding matrix indicated by the TPMI indication information is:

$$[ \begin{matrix}1 & 1 & 0 \\ 1 & 1 & 0 \\ 0 & 0 & 1 \\ 0 & 0 & - 1 \\ 1 & - 1 & 0 \\ - 1 & 1 & 0 \\ 0 & 0 & 1 \\ 0 & 0 & 1\end{matrix} ] ,$$

where two transport layers are transmitted on the antenna ports {0, 1, 4, 5} associated with a PTRS port 0, and one transport layer is transmitted on the antenna ports {2, 3, 6, 7} associated with a PTRS port 1, then at this time, the terminal device may determine the one transport layer associated with the PTRS port 0 in the two transport layers transmitted on the antenna port associated with PTRS port 0 based on the DMRS-PTRS association indication information in DCI, and use the DMRS port used by the transport layer to transmit the PTRS port 0.

Therefore, in the embodiments of the present disclosure, in a case where the uplink 8-antenna port transmission is supported, the terminal device may determine a mapping relationship between the PTRS port and the 8 antenna ports, so that different mapping manners may be determined for different antenna port grouping manners, thereby supporting the uplink 8-antenna port transmission under different antenna arrays.

In some embodiments of the present disclosure, the power boosting value is a boosting value of the transmit power of one PTRS port relative to the transmit power of the DMRS port or transport layer associated with the PTRS port. In a case where the PTRS port is transmitted, there are two main reasons why the PTRS needs to be powered up:
1. Only one PTRS port is transmitted on a resource element (RE) of PTRS, while a plurality of DMRS ports/transport layers are often transmitted on the RE of data or DMRS. At this time, PTRS needs to be powered up relative to DMRS to ensure that the power on each OFDM symbol is constant (regardless of whether PTRS is present or not), otherwise, the RF performance will be affected.
2. If a plurality of PTRS ports are configured, the resources occupied by other PTRS ports need to be reserved on the antenna port that transmits one PTRS port. No signals are transmitted on these reserved resources. Therefore, the power of the reserved resources on these antenna ports may be used for the transmission of the PTRS port, thereby improving the transmission power of the PTRS port.

In the following, in conjunction with embodiment 3, a method for determining the power boosting value of each PTRS port is described.

Embodiment 3: the determination of the power boosting value of the PTRS port.

In some embodiments, the terminal device may determine the power boosting value of the each PTRS port based on the number K of the antenna port groups contained in the X antenna ports and/or the number of transport layers of the PUSCH to be transmitted and/or the number N of configured PTRS ports.

In some embodiments, the terminal device determines the power boosting value of the each PTRS port based on the coherent configuration of the codebook, the number K of antenna port groups contained in the X antenna ports and/or the number of transport layers of the PUSCH to be transmitted.

For example, in a case where a partial-coherent codebook is configured, the terminal device determines the power boosting value of the each PTRS port based on the number K of antenna port groups contained in the X antenna ports and/or the number of transport layers of the PUSCH to be transmitted.

Exemplarily, the power boosting value is 10*lg (N) dB in a case where the number of transport layers of the PUSCH is 2 or 3.

Exemplarily, the power boosting value is 10*lg (4N/K) dB in a case where the number of transport layers of the PUSCH is 4 or 5.

Exemplarily, the power boosting value is 10*lg (N*└6/K┘) in a case where the number of transport layers of the PUSCH is 6 or 7.

Exemplarily, the power boosting value is 10*lg 10*lg (8N/K) dB in a case where the number of transport layers of the PUSCH is 8.

Exemplarily, the power boosting value is 3N−3+10*lg (└L/2┘) dB in a case where K=2 and the number of transport layers of the PUSCH is 2 to 8, where L is the number of transport layers of the PUSCH.

Exemplarily, the power boosting value is 3N−3+3*└L/8┘ in a case where K=4 and the number of transport layers of the PUSCH is 2 to 8, where L is the number of transport layers of the PUSCH.

For another example, in a case where the full coherent codebook is configured, the network device configures only one PTRS port for the terminal device, and the terminal device may determine that the power boosting value on the PTRS port is 10*lg (L) dB, where L represents the number of transport layers of the PUSCH.

For another example, in a case where the non-coherent codebook is configured or non-codebook transmission is configured, the terminal device may determine that the power boosting value of each PTRS port is 10*lg (N) dB. Optionally, if the maximum allowed number Nmax of PTRS ports is 2, 10*lg (N) dB may also be expressed as 3N−3.

Optionally, if the maximum allowed number Nmax of PTRS ports is 4, the terminal device may determine the power boosting value of the each PTRS port in the manner described in the following embodiment 3-1. The maximum number of the PTRS ports may be predefined or configured by the network device.

Optionally, if the maximum allowed number Nmax of PTRS ports is 2, the terminal device may determine the power boosting value of the each PTRS port in the manner described in the following embodiment 3-2, or, may determine the power boosting value of the each PTRS port in the manner described in the following embodiment 3-1. The maximum number of PTRS ports may be predefined or configured by the network device.

Embodiment 3-1: applicable to a case where the maximum allowed number Nmax of PTRS ports is 4, that is, a value range of N is {1, 2, 4}.

At this time, assuming that the value of K is 2 or 4, in a case where the number of transport layers L of the PUSCH is greater than 1, the power boosting value may be determined in the following manner.

As an example, in a case where the number of transport layers of the PUSCH is 2 or 3, the power boosting value of each PTRS port is determined to be 10*lg (N) dB, where N is the number of PTRS ports.

As another example, in a case where the number of transport layers of the PUSCH is 4 or 5, the power boosting value of each PTRS port is determined to be 10*lg (4N/K) dB. For example, in a case where K=2, the power boosting value of the each PTRS port is 10*lg (2N) dB; in a case where K=4, the power boosting value of each PTRS port is 10*lg (N) dB.

As another example, in a case where the number of transport layers of PUSCH is 6 or 7, the power boosting value of each PTRS port is determined to be 10*lg (N*└6/K┘) dB, where └ ┘ represents rounding down, and the rounding down herein may also be replaced by other rounding manners, such as rounding up, rounding off, or the like. For example, in a case where K=2, the power boosting value of the each PTRS port is 10*lg (3N) dB; in a case where K=4, the power boosting value of each PTRS port is 10*lg (N) dB.

As another example, in a case where the number of transport layers of PUSCH is 8, the power boosting value of each PTRS port is 10*lg (8N/K) dB. For example, in a case where K=2, the power boosting value of each PTRS port is 10*lg (4N) dB; in a case where K=4, the power boosting value of each PTRS port is 10*lg (2N) dB.

Table 2 is an example of the power boosting value in a case where the number of transport layers of the PUSCH is 1 to 4, and Table 3 is an example of the power boosting value in a case where the number of transport layers of the PUSCH is 5 to 8.

TABLE 2
Power boosting value in a case where the number of transport layers of PUSCH is 1 to 4 (K = 2/4, Nmax = 2/4)

| | Number of transport layers of (n_{layer}^{PUSCH}) | | | | | | | |
|---|---|---|---|---|---|---|---|---|
| | | 2 | | | | | | |
| | | | partial- | 3 | | | | |
| | | | coherent/non- | | partial-coherent/ | 4 | | |
| | | | coherent | | non-coherent | | | non-coherent |
| | | | codebook | | codebook | | | codebook |
| Power | 1 | full | and | full | and | full | partial- | and |
| boosting | All | coherent | non- | coherent | non- | coherent | coherent | non-code |
| configuration | situations | codebook | codebook | codebook | codebook | codebook | codebook | book |
| 00 | 0 | 3 | 10*lg (N) | 4.77 | 10*lg (N) | 6 | 10*lg | 10*1g (N) |
| | | | | | | | (4N/K) | |
| 01 | 0 | 3 | 3 | 4.77 | 4.77 | 6 | 6 | 6 |

| | |
|---|---|
| 10 | Reserved |
| 11 | Reserved |

TABLE 3
Power boosting value in a case where the number of transport layers
of the PUSCH is 5 to 8 (K = 2/4, Nmax = 2/4)

| | Number of transport layers of PUSCH (n_{layer}^{PUSCH}) | | | | | |
|---|---|---|---|---|---|---|
| | 5 | | | 6 | | |
| | | | non- | | | non- |
| | | | coherent | | | coherent |
| Power | | | codebook | | | codebook |
| boosting | Full | Partial- | and | full | partial- | and |
| config- | coherent | coherent | non- | coherent | coherent | non- |
| uration | codebook | codebook | codebook | codebook | codebook | codebook |
| 00 | 7 | 10*lg | 10*lg | 7.78 | 10*lg(N) + | 10*lg |
| | | (4N/K) | (N) | | 10*lg | (N) |
| | | | | | (└6//K┘) | |
| 01 | 7 | 7 | 7 | 7.78 | 7.78 | 7.78 |

| | |
|---|---|
| 10 | Reserved |
| 11 | Reserved |

Number of transport layers of PUSCH (n_{layer}^{PUSCH})

8

| | 7 | | | | | non- |
|---|---|---|---|---|---|---|
| | | | non- | | | coherent |
| | | | coherent | | | code- |
| | | | codebook | | | book |
| Power | | | and | | | and |
| boosting | full | partial- | non- | full | partial- | non- |
| config- | coherent | coherent | code- | coherent | coherent | code |
| uration | codebook | codebook | book | codebook | codebook | book |
| 00 | 8.45 | 10*lg | 10*lg(N) | 9 | 10*lg(8N/K) | 10*lg |
| | | (N) + | | | | (N) |
| | | 10*lg | | | | |
| | | (└6//K┘) | | | | |
| 01 | 8.45 | 8.45 | 8.45 | 9 | 9 | 9 |

| | |
|---|---|
| 10 | Reserved |
| 11 | Reserved |

Embodiment 3-2: applicable to a case where the maximum allowed number Nmax of PTRS ports is 2, that is, a value range of N is (1,2).

In this case, different power boosting values may be determined based on whether the value of K is 2 or 4.

In some embodiments, in a case where K=2 and the terminal device determines that the number of transport layers of the PUSCH is 2 to 8, the power boosting value of each PTRS port is 3N−3+10*lg (└L/2┘) dB, where L is the number of transport layers of the PUSCH.

Exemplarily, in a case where the number of transport layers is 2 or 3, the power boosting value of the each PTRS port is 3N−3.

Exemplarily, in a case where the number of transport layers is 4 or 5, the power boosting value of the each PTRS port is 3N.

Exemplarily, in a case where the number of transport layers is 6 or 7, the power boosting value of the each PTRS port is 3N+1.77 (or 1.76/1.78).

Exemplarily, in a case where the number of transport layers is 8, the power boosting value of the each PTRS port is 3N+3.

Table 4 is an example of the power boosting value in a case where the number of transport layers of the PUSCH is 1 to 4, and Table 5 is an example of the power boosting value in a case where the number of transport layers of the PUSCH is 5 to 8.

TABLE 4
Power boosting value in a case where the number of transport layers of PUSCH is 1-4 (K = 2, Nmax = 2)

| | Number of transport layers of PUSCH | | | | | | | |
|---|---|---|---|---|---|---|---|---|
| | | 2 | | | | | | |
| | | | partial- | 3 | | | | |
| | | | coherent/ | | partial- | 4 | | |
| | | | non- | | coherent/ | | | non- |
| | | | coherent | | non- | | | coherent |
| | | | codebook | full | coherent | full | | codebook |
| Power | 1 | full | and | coherent | codebook | coherent | partial- | and |
| boosting | All | coherent | non-code | code | and | code | coherent | non-code |
| configuration | situations | codebook | book | book | non-codebook | book | codebook | book |
| 00 | 0 | 3 | 3N − 3 | 4.77 | 3N − 3 | 6 | 3N | 3N − 3 |
| 01 | 0 | 3 | 3 | 4.77 | 4.77 | 6 | 6 | 6 |

| | |
|---|---|
| 10 | Reserved |
| 11 | Reserved |

TABLE 5
Power boosting value in a case where the number of transport layers of PUSCH is 5-8 (K = 2, Nmax = 2)

| | Number of transport layers of PUSCH | | | | | | | | | | | |
|---|---|---|---|---|---|---|---|---|---|---|---|---|
| | 5 | | | 6 | | | | | | 8 | | |
| | | | non- | | | non- | 7 | | | | | non- |
| | | | coher- | | | coher- | | | non- | | | coher- |
| | | | ent | | | ent | | | coher- | | | ent |
| | | | code | | | code- | | | ent | | | code- |
| | full | partial- | book | full | partial- | book | full | partial- | code | full- | partial- | book |
| Power | coher- | coher- | and | coher- | coher- | and | coher- | coher- | book | coher- | coher- | and |
| boosting | ent | ent | non- | ent | ent | non- | ent | ent | and | ent | ent | non- |
| config- | code- | code- | code- | code- | code- | code- | code- | code- | noncode- | code- | code | code- |
| uration | book | book | book | book | book | book | book | book | book | book | book | book |
| 00 | 7 | 3N | 3N − 3 | 7.78 | 3N + 1.77 | 3N − 3 | 8.45 | 3N + 1.77 | 3N − 3 | 9 | 3N + 3 | 3N − 3 |
| 01 | 7 | 7 | 7 | 7.78 | 7.78 | 7.78 | 8.45 | 8.45 | 8.45 | 9 | 9 | 9 |

| | |
|---|---|
| 10 | Reserved |
| 11 | Reserved |

In some other embodiments, in a case where K=4 and the terminal device determines that the number of transport layers of the PUSCH is 2 to 8, the power boosting value of the each PTRS port is 3N−3+3*└L/8┘, where L is the number of transport layers of the PUSCH. Table 6 is an example table of power boosting values in a case where the number of transport layers of the PUSCH is 1 to 4, and Table 7 is a comparison table of power boosting values in a case where the number of transport layers of the PUSCH is 5-8.

For example, in a case where the number of transport layers of the PUSCH is 2-7, the power boosting value of the each PTRS port is 3N−3.

For another example, in a case where the number of transport layers of the PUSCH is 8, the power boosting value of the each PTRS port is 3N.

TABLE 6
Power boosting values in a case where the number of transport layers of PUSCH is 1 to 4 (K = 4, Nmax = 2)

| | Number of transport layers of PUSCH | | | | | | |
|---|---|---|---|---|---|---|---|
| | | 2 | | | | | |
| | | | partial- | | | | |
| | | | coherent/non- | | | | |
| | | | coherent | 3 | | 4 | |
| | | | codebook | full | partial-coherent/ | full | partial-coherent/ |
| Power | 1 | full | and | coherent | non-coherent | coherent | non-coherent |
| boosting | All | coherent | non- | code | codebook and | code | codebook and |
| configuration | situations | codebook | codebooks | book | non-codebook | book | non-codebook |
| 00 | 0 | 3 | 3N − 3 | 4.77 | 3N − 3 | 6 | 3N − 3 |
| 01 | 0 | 3 | 3 | 4.77 | 4.77 | 6 | 6 |

| | |
|---|---|
| 10 | Reserved |
| 11 | Reserved |

TABLE 7
Power boosting value in a case where the number of transport layers PUSCH is 5-8 (K = 4, Nmax = 2)

| | Number of transport layers of PUSCH | | | | | | | | |
|---|---|---|---|---|---|---|---|---|---|
| | 5 | | 6 | | | | | | |
| | | partial- | | partial- | 7 | | | | |
| | | coherent/ | | coherent/ | | partial- | | | |
| | | non- | | non- | | coherent/ | 8 | | |
| | | coherent | | coherent | | non-coherent | | | non-coherent |
| | | codebook | | codebook | full | codebook | | | codebook |
| Power | full | and | full | and | coherent | and | full | partial- | and |
| boosting | coherent | non- | coherent | non-code | code- | non-code | coherent | coherent | non-code |
| configuration | codebook | codebook | codebook | book | book | book | codebook | codebook | book |
| 00 | 7 | 3N − 3 | 7.78 | 3N − 3 | 8.45 | 3N − 3 | 9 | 3N | 3N − 3 |
| 01 | 7 | 7 | 7.78 | 7.78 | 8.45 | 8.45 | 9 | 9 | 9 |

| | |
|---|---|
| 10 | Reserved |
| 11 | Reserved |

In some embodiments, 7.78 in the above table may also be expressed as 7.77, and 1.77 may also be expressed as 1.76 or 1.78.

It should be noted that the above table only gives a general expression of the power boosting values. In practical applications, other expressions may also be used, as long as power boosting values corresponding to different transport layers obtained at last are the same as the values obtained by the above expressions or tables. The embodiments of the present disclosure do not limit the specific expression manner. For example, in Table 3, in a case where the number of transport layers is 6 or 7, 10*lg (N)+10*lg (└6/K┘) may also be expressed as 10*lg (N)+10*lg (5−K) or 10*lg (N)+10*lg (8/K−1).

Therefore, in embodiments of the present disclosure, in a case where the uplink 8-antenna port transmission is supported, the terminal device may determine the power boosting value of each PTRS port, so as to ensure that power on different orthogonal frequency-division multiplexing (OFDM) symbols is constant in the 8-antenna port transmission under different antenna array conditions, thereby ensuring the RF performance, and the power boosting is beneficial to enhancing the measurement performance on the PTRS port.

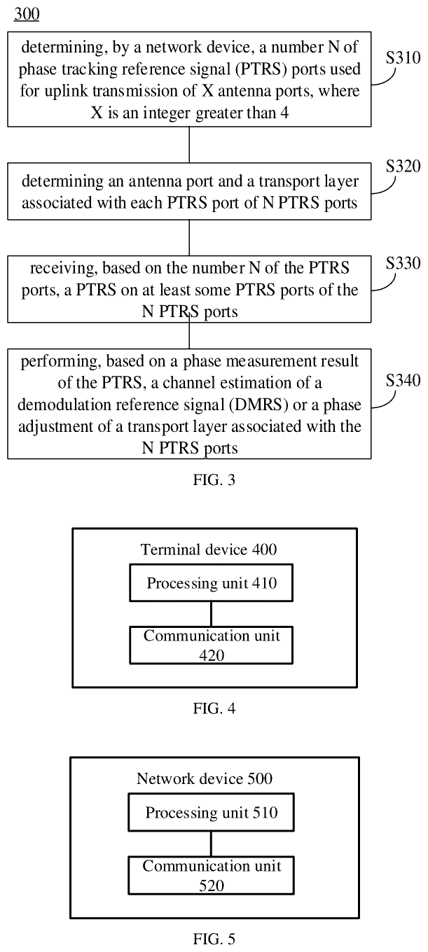

The wireless communication method according to an embodiment of the present disclosure is described in detail from the point of view of the terminal device in conjunction with FIG. 2 above. The wireless communication method according to another embodiment of the present disclosure is described in detail from the point of view of the network device in conjunction with FIG. 3 below. It should be understood that the description on the network device side corresponds to the description on the terminal device side, and similar descriptions may be found above and will not be repeated herein to avoid repetition.

FIG. 3 is a schematic flow chart of a wireless communication method 300 according to another embodiment of the present disclosure. The method 300 may be executed by the network device in the communication system shown in FIG. 1. As shown in FIG. 3, the method 300 includes the following contents.

In S310, a network device determines a number N of phase tracking reference signal (PTRS) ports used for uplink transmission of X antenna ports.

In S320, an antenna port and a transport layer associated with each PTRS port of N PTRS ports are determined.

In S330, a PTRS is received on at least some of the N PTRS ports based on the number N of the PTRS ports.

In S340, a channel estimation of a demodulation reference signal (DMRS) or a phase adjustment of a transport layer associated with the N PTRS ports is performed based on a phase measurement result of the PTRS.

In the method 300, the network device may determine the number N of PTRS ports, the antenna port and the transport layer associated with the each PTRS port in a manner similar to that in the terminal device. The specific implementation refers to the description in the method 200, which will not be repeated herein for brevity.

In some embodiments, the S310 includes:
determining, based on the number K of antenna port groups contained in the X antenna ports, the number N of the PTRS ports.

In some embodiments, the number N of PTRS ports is less than or equal to K.

In some embodiments, the number N of the PTRS ports is equal to K, in a case where a partial-coherent codebook is configured or a non-coherent codebook is configured.

In some embodiments, the number N of the PTRS ports is equal to K, in a case where a non-coherent codebook is configured;
the number N of the PTRS ports is less than or equal to K, in a case where a partial-coherent codebook is configured; and
the number N of the PTRS ports is 1, in a case where a full coherent codebook is configured.

In some embodiments, the S320 may include:
determining, based on the number K of antenna port groups contained in the X antenna ports, the antenna port and the transport layer associated with the each PTRS port in a case where a partial-coherent codebook is configured.

In some embodiments, X=8, where
a PTRS port 0 is associated with antenna ports {0, 1, 4, 5} and a PTRS port 1 is associated with antenna ports {2, 3, 6, 7} in a case where K=2; and
a PTRS port 0 is associated with antenna ports {0, 4}, a PTRS port 1 is associated with antenna ports {1, 5}, a PTRS port 2 is associated with antenna ports {2, 6} and a PTRS port 3 is associated with antenna ports {3, 7} in a case where K=4.

In some embodiments, the S320 may include:
determining an antenna port group of antenna port groups contained in the X antenna ports associated with the each PTRS port; where an antenna port contained in the each antenna port group is preconfigured by a network device.

In some embodiments, the S320 may include:
determining that a PTRS port 0 is associated with antenna ports {0, 1, 4, 5} and a PTRS port 1 is associated with antenna ports {2, 3, 6, 7}, in a case where the number N of the PTRS ports is equal to 2; and
determining that a PTRS port 0 is associated with antenna ports {0, 4}, a PTRS port 1 is associated with antenna ports {1, 5}, a PTRS port 2 is associated with antenna ports {2, 6}, and a PTRS port 3 is associated with antenna ports {3, 7} in a case where the number N of the PTRS ports is equal to 4.

In some embodiments, the S320 may include:
determining that a first PTRS port is associated with a first antenna port set for transmitting a first transport layer, and a second PTRS port is associated with a second antenna port set for transmitting a second transport layer, where the first transport layer and the second transport layer are different PUSCH transport layers, where the first antenna port set and the second antenna port set are different, where the first PTRS port and the second PTRS port are different.

In some embodiments, the method 300 further includes:
determining, based on the antenna port associated with the each PTRS port and transmitted precoding matrix indicator (TPMI) indication information in downlink control information (DCI), a number M of PTRS ports actually used for the uplink transmission of X antenna ports.

In some embodiments, the number M of PTRS ports actually used for the uplink transmission of X antenna ports is a number of all PTRS ports associated with an antenna port corresponding to a non-zero element in a precoding matrix indicated by the TPMI indication information.

In some embodiments, the S320 may include:
determining, based on demodulation reference signal (DMRS)-PTRS association indication information in DCI, a transport layer associated with the PTRS port from a first transport layer set, where the first transport layer set includes transport layers transmitted on an antenna port associated with the PTRS port.

In some embodiments, the method 300 further includes:
determining, based on DMRS-PTRS association indication information in DCI, a DMRS port associated with the PTRS port from a first DMRS port set, where the first DMRS port set includes DMRS ports transmitted on an antenna port associated with the PTRS port.

In some embodiments, the number K of antenna port groups contained in the X antenna ports is configured by a network device.

In some embodiments, the number K of antenna port groups contained in the X antenna ports is configured through a high-layer signaling.

In some embodiments, the method 300 further includes:
receiving, by the network device, a number K of antenna port groups contained in X antenna ports reported by a terminal device, where K is used to determine the number N of the PTRS ports, and/or the antenna port and the transport layer associated with the each PTRS port.

The method embodiments of the present disclosure are described in detail with reference to FIG. 2 to FIG. 3 above, and the apparatus embodiments of the present disclosure are described in detail below with reference to FIG. 4 to FIG. 7. It should be understood that the apparatus embodiments and the method embodiments correspond to each other, and similar descriptions may refer to the method embodiments.

FIG. 4 shows a schematic block diagram of a terminal device 400 according to the embodiments of the present disclosure. As shown in FIG. 4, the terminal device 400 includes:
a processing unit 410, configured to determine a number N of phase tracking reference signal (PTRS) ports used for uplink transmission of X antenna ports, where X is an integer greater than 4; determine an antenna port and a transport layer associated with each PTRS port of N PTRS ports; and determine a power boosting value of the each PTRS port of the N PTRS ports; and
a communication unit 420, configured to transmit a PTRS on at least some PTRS ports of the N PTRS ports based on the antenna port and the transport layer associated with the each PTRS port, as well as the power boosting value of the each PTRS port.

In some embodiments, the processing unit 410 is further configured to:
determine, based on a number K of antenna port groups contained in the X antenna ports, the number N of the PTRS ports.

In some embodiments, the number N of the PTRS ports is less than or equal to K.

In some embodiments, the number N of the PTRS ports is equal to K, in a case where a partial-coherent codebook is configured or a non-coherent codebook is configured.

In some embodiments, the number N of the PTRS ports is equal to K, in a case where a non-coherent codebook is configured;
the number N of the PTRS ports is configured by a network device and N is less than or equal to K, in a case where a partial-coherent codebook is configured; and
the number N of the PTRS ports is 1, in a case where a full coherent codebook is configured.

In some embodiments, the processing unit 410 is further configured to:
determine, based on a number K of antenna port groups contained in the X antenna ports, the antenna port and the transport layer associated with the each PTRS port in a case where a partial-coherent codebook is configured.

In some embodiments, X=8, where
a PTRS port 0 is associated with antenna ports {0, 1, 4, 5} and a PTRS port 1 is associated with antenna ports {2, 3, 6, 7} in a case where K=2; and
a PTRS port 0 is associated with antenna ports {0, 4}, a PTRS port 1 is associated with antenna ports {1, 5}, a PTRS port 2 is associated with antenna ports {2, 6} and a PTRS port 3 is associated with antenna ports {3, 7} in a case where K=4.

In some embodiments, the processing unit 410 is further configured to:
determine an antenna port group of antenna port groups contained in the X antenna ports associated with the each PTRS port; where an antenna port contained in the each antenna port group is preconfigured by a network device.

In some embodiments, the processing unit 410 is further configured to:
determine that a PTRS port 0 is associated with antenna ports {0, 1, 4, 5} and a PTRS port 1 is associated with antenna ports {2, 3, 6, 7} in a case where the number N of the PTRS ports is equal to 2; and
determine that a PTRS port 0 is associated with antenna ports {0, 4}, a PTRS port 1 is associated with antenna ports {1, 5}, a PTRS port 2 is associated with antenna ports {2, 6}, and a PTRS port 3 is associated with antenna ports {3, 7} in a case where the number N of the PTRS ports is equal to 4.

In some embodiments, the processing unit 410 is further configured to:
determine that a first PTRS port is associated with a first antenna port set for transmitting a first transport layer, and a second PTRS port is associated with a second antenna port set for transmitting a second transport layer, where the first transport layer and the second transport layer are different PUSCH transport layers, the first antenna port set and the second antenna port set are different, and the first PTRS port and the second PTRS port are different.

In some embodiments, the processing unit 410 is further configured to:
determine, based on the antenna port associated with the each PTRS port and transmitted precoding matrix indicator (TPMI) indication information in downlink control information (DCI), a number M of PTRS ports actually used for the uplink transmission of X antenna ports.

In some embodiments, a number M of PTRS ports actually used for the uplink transmission of X antenna ports is a number of all PTRS ports associated with an antenna port corresponding to a non-zero element in a precoding matrix indicated by the TPMI indication information.

In some embodiments, the processing unit 410 is further configured to:
determine, based on demodulation reference signal (DMRS)-PTRS association indication information in DCI, a transport layer associated with the PTRS port from a first transport layer set, where the first transport layer set includes transport layers transmitted on an antenna port associated with the PTRS port.

In some embodiments, the processing unit 410 is further configured to:
determine, based on DMRS-PTRS association indication information in DCI, a DMRS port associated with the PTRS port from a first DMRS port set, where the first DMRS port set includes DMRS ports transmitted on an antenna port associated with the PTRS port.

In some embodiments, the processing unit 410 is further configured to:
determine, based on a number K of antenna port groups contained in the X antenna ports and a number of transport layers of a physical uplink shared channel (PUSCH) to be transmitted, a power boosting value of each PTRS port, in a case where a partial-coherent codebook is configured.

In some embodiments, the power boosting value is 10*lg (N) dB in a case where the number of transport layers of the PUSCH is 2 or 3;
the power boosting value is 10*lg (4N/K) dB in a case where the number of transport layers of the PUSCH is 4 or 5;
the power boosting value is 10*lg (N*└6/K┘) dB in a case where the number of transport layers of the PUSCH is 6 or 7; and
the power boosting value is 10*lg 10*lg (8N/K) dB in a case where the number of transport layers of the PUSCH is 8.

In some embodiments, the power boosting value is 3N−3+10*lg (└L/2┘) dB in a case where K=2 and the number of transport layers of the PUSCH is 2 to 8, where L is the number of transport layers of the PUSCH;
the power boosting value is 3N−3+3*└L/8┘ in a case where K=4 and the number of transport layers of the PUSCH is 2 to 8, where L is the number of transport layers of the PUSCH.

In some embodiments, the processing unit 410 is further configured to:
determine that the power boosting value of the each PTRS port is 10*lg (N) dB in a case where a non-coherent codebook is configured.

In some embodiments, the number K of antenna port groups contained in the X antenna ports is configured by a network device through a high-layer signaling.

In some embodiments, the communication unit 420 is further configured to:
report a number K of antenna port groups contained in the X antenna ports to a network device, where K is used to determine at least one of the number N of the PTRS ports, the antenna port and the transport layer associated with the each PTRS port, or the power boosting value of the each PTRS port.

Optionally, in some embodiments, the above communication unit may be a communication interface or a transceiver, or an input/output interface of a communication chip or a system on chip. The above processing unit mentioned may be one or more processor.

It should be understood that the terminal device 400 according to the embodiments of the present disclosure may correspond to the terminal device in the method embodiments of the present disclosure, and the above and other operations and/or functions of each unit in the terminal device 400 are respectively for implementing corresponding processes of the terminal device in the method 200 shown in FIG. 2, which will not be repeated herein for the sake of brevity.

FIG. 5 is a schematic block diagram of a network device according to the embodiments of the present disclosure. The network device 500 of FIG. 5 includes:
a processing unit 510, configured to determine a number N of phase tracking reference signal (PTRS) ports used for uplink transmission of X antenna ports, where X is an integer greater than 4; determine an antenna port and a transport layer associated with each PTRS port of N PTRS ports; and receive a PTRS on at least some PTRS ports of the N PTRS ports based on the number N of the PTRS ports;
a communication unit 520, configured to perform a channel estimation of a demodulation reference signal (DMRS) or a phase adjustment of a transport layer associated with the N PTRS ports, based on a phase measurement result of the PTRS.

In some embodiments, the processing unit 510 is further configured to:
determining, based on a number K of antenna port groups contained in the X antenna ports, the number N of the PTRS ports.

In some embodiments, the number N of the PTRS ports is less than or equal to K.

In some embodiments, the number N of the PTRS ports is equal to K, in a case where a partial-coherent codebook is configured or a non-coherent codebook is configured.

In some embodiments, the number N of the PTRS ports is equal to K, in a case where a non-coherent codebook is configured;
the number N of the PTRS ports is less than or equal to K, in a case where a partial-coherent codebook is configured;
the number N of the PTRS ports is 1, in a case where a full coherent codebook is configured.

In some embodiments, the processing unit 510 is further configured to:
determine, based on a number K of antenna port groups contained in the X antenna ports, the antenna port and the transport layer associated with the each PTRS port in a case where a partial-coherent codebook is configured.

In some embodiments, X=8, where
a PTRS port 0 is associated with antenna ports {0, 1, 4, 5} and a PTRS port 1 is associated with antenna ports {2, 3, 6, 7} in a case where K=2;
a PTRS port 0 is associated with antenna ports {0, 4}, a PTRS port 1 is associated with antenna ports {1, 5}, a PTRS port 2 is associated with antenna ports {2, 6} and a PTRS port 3 is associated with antenna ports {3, 7} in a case where K=4.

In some embodiments, the processing unit 510 is further configured to:
determine an antenna port group of antenna port groups contained in the X antenna ports associated with the each PTRS port; where an antenna port contained in each antenna port group is preconfigured by a network device.

In some embodiments, the processing unit 510 is further configured to:
determine that a PTRS port 0 is associated with antenna ports {0, 1, 4, 5} and a PTRS port 1 is associated with antenna ports {2, 3, 6, 7}, in a case where the number N of the PTRS ports is equal to 2; and
determining that a PTRS port 0 is associated with antenna ports {0, 4}, a PTRS port 1 is associated with antenna ports {1, 5}, a PTRS port 2 is associated with antenna ports {2, 6}, and a PTRS port 3 is associated with antenna ports {3, 7}, in a case where the number N of the PTRS ports is equal to 4.

In some embodiments, the processing unit 510 is further configured to:
determine that a first PTRS port is associated with a first antenna port set for transmitting a first transport layer, and a second PTRS port is associated with a second antenna port set for transmitting a second transport layer, where the first transport layer and the second transport layer are different, the first antenna port set and the second antenna port set are different, and the first PTRS port and the second PTRS port are different.

In some embodiments, the processing unit 510 is further configured to:
determine, based on the antenna port associated with the each PTRS port and transmitted precoding matrix indicator (TPMI) indication information in downlink control information (DCI), a number M of PTRS ports actually used for the uplink transmission of X antenna ports.

In some embodiments, a number M of PTRS ports actually used for the uplink transmission of X antenna ports is a number of all PTRS ports associated with an antenna port corresponding to a non-zero element in a precoding matrix indicated by the TPMI indication information.

In some embodiments, the processing unit 510 is further configured to:
determine, based on demodulation reference signal (DMRS)-PTRS association indication information in DCI, a transport layer associated with the PTRS port from a first transport layer set, where the first transport layer set includes transport layers transmitted on an antenna port associated with the PTRS port.

In some embodiments, the processing unit 510 is further configured to:
determine, based on DMRS-PTRS association indication information in DCI, a DMRS port associated with the PTRS port from a first DMRS port set, where the first DMRS port set includes DMRS ports transmitted on an antenna port associated with the PTRS port.

In some embodiments, a number K of antenna port groups contained in the X antenna ports is configured by a network device through a high-layer signaling.

In some embodiments, the communication unit 520 is further configured to:
receive a number K of antenna port groups contained in X antenna ports reported by a terminal device, where K is used to determine the number N of the PTRS ports, and/or the antenna port and the transport layer associated with the each PTRS port.

Optionally, in some embodiments, the above communication unit may be a communication interface or a transceiver, or an input/output interface of a communication chip or a system on chip. The above processing unit may be one or more processors.

It should be understood that the network device 500 according to the embodiments of the present disclosure may correspond to the network device in the embodiments of the method of the present disclosure, and the above and other operations and/or functions of each unit in the network device 500 are respectively for implementing corresponding processes of the network device in the method 300 shown in FIG. 3, which will not be repeated herein for the sake of brevity.

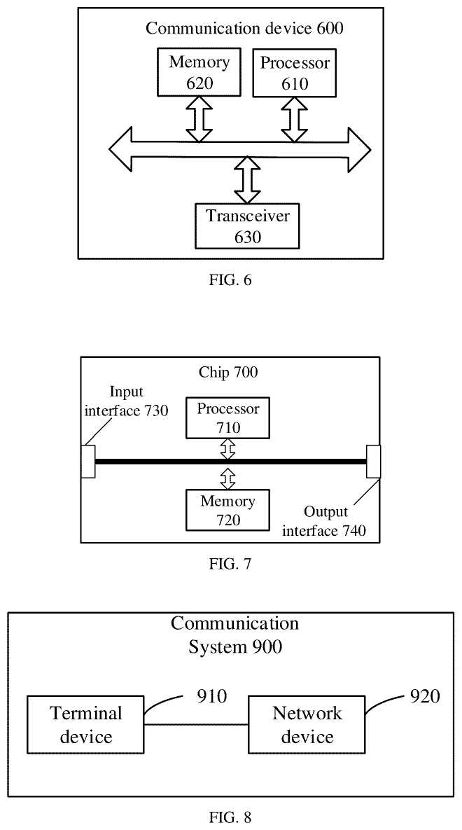

FIG. 6 is a schematic structural diagram of a communication device 600 provided in an embodiment of the present disclosure. The communication device 600 shown in FIG. 6 includes a processor 610, and the processor 610 may call a computer program from a memory and run the computer program to implement the methods in the embodiments of the present disclosure.

Optionally, as shown in FIG. 6, the communication device 600 may further include a memory 620. The processor 610 may call the computer program from the memory 620 and run the computer program to implement the methods in the embodiments of the present disclosure.

The memory 620 may be a separate device independent of the processor 610, or may be integrated into the processor 610.

Optionally, as shown in FIG. 6, the communication device 600 may further include a transceiver 630, and the processor 610 may control the transceiver 630 to communicate with other devices, specifically, may transmit information or data to other devices, or receive information or data transmitted from other devices.

The transceiver 630 may include a transmitter and a receiver. The transceiver 630 may further include an antenna, and the number of the antenna(s) may be one or more.

Optionally, the communication device 600 may specifically be a network device of the embodiments of the present disclosure, and the communication device 600 may implement corresponding processes implemented by the network device in each method of the embodiments of the present disclosure, which will not be repeated herein for the sake of brevity.

Optionally, the communication device 600 may specifically be a mobile terminal/terminal device of the embodiments of the present disclosure, and the communication device 600 may implement corresponding processes implemented by the mobile terminal/terminal device in each method of the embodiments of the present disclosure, which will not be repeated herein for the sake of brevity.

FIG. 7 is a schematic structural diagram of a chip according to the embodiments of the present disclosure. The chip 700 shown in FIG. 7 includes a processor 710, and the processor 710 may call a computer program from a memory and run the computer program to implement the methods in the embodiments of the present disclosure.

Optionally, as shown in FIG. 7, the chip 700 may further include a memory 720. The processor 710 may call the computer program from the memory 720 and run the computer program to implement the methods in the embodiments of the present disclosure.

The memory 720 may be a separate device independent of the processor 710, or may be integrated into the processor 710.

Optionally, the chip 700 may further include an input interface 730. The processor 710 may control the input interface 730 to communicate with other devices or chips, and specifically, may acquire information or data transmitted from other devices or chips.

Optionally, the chip 700 may further include an output interface 740. The processor 710 may control the output interface 740 to communicate with other devices or chips, and specifically, may output information or data to other devices or chips.

Optionally, the chip may be applied to the network device in the embodiments of the present disclosure, and the chip may implement corresponding processes implemented by the network device in each method of the embodiments of the present disclosure, which will not be repeated herein for the sake of brevity.

Optionally, the chip may be applied to the mobile terminal/terminal device in the embodiments of the present disclosure, and the chip may implement corresponding processes implemented by the mobile terminal/terminal device in each method of the embodiments of the present disclosure, which will not be repeated herein for the sake of brevity.

It should be understood that the chip mentioned in the embodiments of the present disclosure may also be called a system-level chip, a system chip, a chip system or a system-on-chip.

FIG. 8 is a schematic block diagram of a communication system 900 provided in the embodiments of the present disclosure. As shown in FIG. 8, the communication system 900 includes a terminal device 910 and a network device 920.

The terminal device 910 may be used to implement corresponding functions implemented by the terminal device in the above methods, and the network device 920 may be used to implement corresponding functions implemented by the network device in the above methods, which will not be repeated herein for the sake of brevity.

It should be understood that the processor in the embodiments of the present disclosure may be an integrated circuit chip with signal processing capabilities. In the implementation process, each step in the above method embodiments may be completed by an integrated logic circuit of hardware in a processor or instructions in a software form in the processor. The above processor may be a general purpose processor, a digital signal processor (DSP), an application specific integrated circuit (ASIC), a field programmable gate array (FPGA) or another programmable logic device, a discrete gate, a transistor logic device, or a discrete hardware component, which may implement or execute the disclosed methods, steps and logic block diagrams in the embodiments of the present disclosure. The general purpose processor may be a microprocessor, or the processor may be any conventional processor. The steps of the methods disclosed in conjunction with the embodiments of the present disclosure may be directly implemented as being executed by the hardware decoding processor, or may be implemented by a combination of the hardware and software modules in the decoding processor. The software module may be located in a random memory, a flash memory, a read-only memory, a programmable read-only memory, an electrically erasable programmable memory, a register or other mature storage media in the art. The storage medium is located in the memory, and the processor reads information in the memory and completes the steps of the above method in combination with hardware thereof.

It can be understood that the memory in the embodiments of the present disclosure may be a volatile memory or a non-volatile memory, or may include both volatile and non-volatile memories. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random access memory (RAM), which is used as an external cache. As an example but not a limitation, a variety of forms of RAMs are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct memory bus random access memory (Direct Rambus RAM, DR RAM). It should be noted that the memory of the systems and methods described herein is intended to include, but is not limited to, these and any other suitable types of memories.

It should be understood that the above memories are exemplary but not limited illustration. For example, the memory in the embodiments of the present disclosure may be a static random access memory (static RAM, SRAM), a dynamic random access memory (dynamic RAM, DRAM), a synchronous dynamic random access memory (synchronous DRAM, SDRAM)), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), or a direct memory bus random access memory (Direct Rambus RAM, DR RAM). That is, the memories in the embodiments of the present disclosure are intended to include, but not limited to, these and any other suitable types of memories.

The embodiments of the present disclosure further provide a non-transitory computer-readable storage medium for storing a computer program.

Optionally, the non-transitory computer-readable storage medium may be applied to the network device in the embodiments of the present disclosure, and the computer program enables a computer to perform corresponding processes implemented by the network device in the various methods in the embodiments of the present disclosure, which will not be repeated herein for the sake of brevity.

Optionally, the non-transitory computer-readable storage medium may be applied to the mobile terminal/terminal device in the embodiments of the present disclosure, and the computer program enables a computer to perform corresponding processes implemented by the mobile terminal/terminal device in the various methods in the embodiments of the present disclosure, which will not be repeated herein for the sake of brevity.

The embodiments of the present disclosure further provide a computer program product including computer program instructions.

Optionally, the computer program product may be applied to the network device in the embodiments of the present disclosure, and the computer program instructions enable a computer to perform corresponding processes implemented by the network device in the various methods in the embodiments of the present disclosure, which will not be repeated herein for the sake of brevity.

Optionally, the computer program product may be applied to the mobile terminal/terminal device in the embodiments of the present disclosure, and the computer program instructions enable a computer to perform corresponding processes implemented by the mobile terminal/terminal device in the various methods in the embodiments of the present disclosure, which will not be repeated herein for the sake of brevity.

The embodiments of the present disclosure further provide a computer program.

Optionally, the computer program may be applied to the network device in the embodiments of the present disclosure. The computer program, upon being run on a computer, enables the computer to perform corresponding processes implemented by the network device in the various methods in the embodiments of the present disclosure, which will not be repeated herein for the sake of brevity.

Optionally, the computer program may be applied to the mobile terminal/terminal device in the embodiments of the present disclosure. The computer program, upon being run on a computer, enables the computer to perform corresponding processes implemented by the mobile terminal/terminal device in the various methods in the embodiments of the present disclosure, which will not be repeated herein for the sake of brevity.

Those of ordinary skill in the art will appreciate that units and algorithm steps of all examples described in conjunction with the embodiments disclosed herein may be implemented by electronic hardware, or by a combination of computer software and electronic hardware. Whether these functions are performed in hardware or software depends on the specific application and design constraints of the technical solutions. A professional may use different methods to implement the described functions for each specific application, but such implementation should not be considered beyond the scope of the present disclosure.

It may be clearly understood by those skilled in the art that for convenience and brevity of the description, the specific operating processes of the system, apparatus and unit described above may refer to corresponding processes in the above method embodiments, which will not be repeated herein.

In several embodiments provided by the present disclosure, it should be understood that the disclosed system, apparatus and method may be implemented in other ways. For example, the apparatus embodiments described above are only schematic. For example, the division of the units is only division of logical functions, and there may be other division ways in the actual implementation, for example, a plurality of units or components may be combined or integrated into another system, or some features may be ignored or not implemented. In addition, the mutual coupling or direct coupling or communication connection illustrated or discussed may be indirect coupling or communication connection through some interfaces, apparatuses or units, and may be in electrical, mechanical or other forms.

The units described as separation components may or may not be physically separated, and the components shown as units may or may not be physical units, that is, they may be located at one place, or may be distributed onto a plurality of network units. Some or all of the units may be selected according to actual requirements to implement the purpose of the schemes of the embodiments.

In addition, various functional units in various embodiments of the present disclosure may be integrated into one processing unit, or various units may exist physically alone, or two or more units may be integrated into one unit.

If the functions are implemented in the form of a software functional unit and sold or used as an independent product, they may be stored in a computer readable storage medium. Based on such an understanding, the technical solutions of the present disclosure in essence or a part of the technical solution that contributes to the prior art or a part of the technical solution, may be embodied in the form of a software product, and the computer software product is stored in a storage medium and includes several instructions for making a computer device (which may be a personal computer, a server, a network device, or the like) to perform all or part of steps of the methods described in various embodiments of the present disclosure. The aforementioned storage media includes a U disk, a mobile hard disk, a read-only memory (ROM), a random access memory (RAM), a disk, an optical disk, and other media that may store program codes.

The foregoing descriptions are merely specific implementations of the present disclosure, but the protection scope of the present disclosure is not limited thereto. Any skilled person in the art could readily conceive of changes or replacements within the technical scope of the present disclosure, which shall be all included in the protection scope of the present disclosure. Therefore, the protection scope of the present disclosure shall be subject to the protection scope of claims.

What is claimed is:

1. A wireless communication method, comprising:
determining, by a terminal device, a number N of phase tracking reference signal (PTRS) ports used for uplink transmission of X antenna ports, wherein X is a positive integer greater than 4;
determining an antenna port and a transport layer associated with each PTRS port of N PTRS ports;
determining a power boosting value of the each PTRS port of the N PTRS ports; and
transmitting, based on the antenna port and the transport layer associated with the each PTRS port, as well as the power boosting value of the each PTRS port, a PTRS on at least some PTRS ports of the N PTRS ports.

2. The method according to claim 1, wherein determining the antenna port and the transport layer associated with the each PTRS port of the N PTRS ports comprises:
determining that the PTRS port is associated with all antenna ports, in a case where the number N of PTRS ports is equal to 1; and
determining that a PTRS port 0 is associated with antenna ports {0, 1, 4, 5} and a PTRS port 1 is associated with antenna ports {2, 3, 6, 7} in a case where the number N of the PTRS ports is equal to 2.

3. The method according to claim 2, further comprising:
determining, by the terminal device based on the antenna port associated with the each PTRS port and transmitted precoding matrix indicator (TPMI) indication information in downlink control information (DCI), a number M of PTRS ports actually used for the uplink transmission of the X antenna ports.

4. The method according to claim 3, wherein the number M of PTRS ports actually used for the uplink transmission of the X antenna ports is a number of all PTRS ports associated with the antenna ports corresponding to a non-zero element in a precoding matrix indicated by the TPMI indication information.

5. The method according to claim 1, wherein determining the antenna port and the transport layer associated with the each PTRS port of the N PTRS ports comprises:
determining, by the terminal device based on demodulation reference signal (DMRS)-PTRS association indication information in DCI, a transport layer associated with the PTRS port from a first transport layer set, wherein the first transport layer set comprises transport layers transmitted on an antenna port associated with the PTRS port.

6. The method according to claim 1, further comprising:
determining, by the terminal device based on DMRS-PTRS association indication information in DCI, a DMRS port associated with the PTRS port from a first DMRS port set, wherein the first DMRS port set comprises DMRS ports transmitted on an antenna port associated with the PTRS port.

7. The method according to claim 1, wherein determining the power boosting value of the each PTRS port of the N PTRS ports comprises:
determining that the power boosting value of the each PTRS port is 10*lg (N) dB in a case where a non-coherent codebook is configured.

8. A wireless communication method, comprising:
determining, by a network device, a number N of phase tracking reference signal (PTRS) ports used for uplink transmission of X antenna ports, wherein X is an integer greater than 4;
determining an antenna port and a transport layer associated with each PTRS port of N PTRS ports;
receiving, based on the number N of the PTRS ports, a PTRS on at least some PTRS ports of the N PTRS ports; and
performing, based on a phase measurement result of the PTRS, a channel estimation of the demodulation reference signal (DMRS) associated with the at least some PTRS ports or a phase adjustment of a transport layer associated with the PTRS ports.

9. The method according to claim 8, wherein determining the antenna port and the transport layer associated with the each PTRS port of the N PTRS ports comprises:
determining, based on a number K of antenna port groups contained in the X antenna ports, the antenna port and the transport layer associated with the each PTRS port in a case where a partial-coherent codebook is configured.

10. The method according to claim 8, wherein determining the antenna port and the transport layer associated with the each PTRS port of the N PTRS ports comprises:
determining that the PTRS port is associated with all antenna ports, in a case where the number N of PTRS ports is equal to 1; and
determining that a PTRS port 0 is associated with antenna ports {0, 1, 4, 5} and a PTRS port 1 is associated with antenna ports {2, 3, 6, 7}, in a case where the number N of the PTRS ports is equal to 2.

11. The method according to claim 9, further comprising:
determining, based on the antenna port associated with the each PTRS port and transmitted precoding matrix indicator (TPMI) indication information in downlink control information (DCI), a number M of PTRS ports actually used for the uplink transmission of the X antenna ports.

12. The method according to claim 11, wherein the number M of PTRS ports actually used for the uplink transmission of the X antenna ports is a number of all PTRS ports associated with an antenna port corresponding to a non-zero element in a precoding matrix indicated by the TPMI indication information.

13. A terminal device, comprising: a processor and a memory, wherein the memory is configured to store a computer program, and the processor is configured to call and run the computer program stored in the memory to cause the terminal device to perform:
determining a number N of phase tracking reference signal (PTRS) ports used for uplink transmission of X antenna ports, wherein X is a positive integer greater than 4;
determining an antenna port and a transport layer associated with each PTRS port of N PTRS ports;
determining a power boosting value of the each PTRS port of the N PTRS ports; and
transmitting, based on the antenna port and the transport layer associated with the each PTRS port, as well as the power boosting value of the each PTRS port, a PTRS on at least some PTRS ports of the N PTRS ports.

14. The terminal device according to claim 13, wherein determining the antenna port and the transport layer associated with the each PTRS port of the N PTRS ports comprises:
determining that the PTRS port is associated with all antenna ports, in a case where the number N of PTRS ports is equal to 1; and
determining that a PTRS port 0 is associated with antenna ports {0, 1, 4, 5} and a PTRS port 1 is associated with antenna ports {2, 3, 6, 7} in a case where the number N of the PTRS ports is equal to 2.

15. The terminal device according to claim 14, wherein the processor causes the terminal device to further perform:
determining, based on the antenna port associated with the each PTRS port and transmitted precoding matrix indicator (TPMI) indication information in downlink control information (DCI), a number M of PTRS ports actually used for the uplink transmission of the X antenna ports.

16. The terminal device according to claim 15, wherein the number M of PTRS ports actually used for the uplink transmission of the X antenna ports is a number of all PTRS ports associated with the antenna ports corresponding to a non-zero element in a precoding matrix indicated by the TPMI indication information.

17. The terminal device according to claim 13, wherein determining the antenna port and the transport layer associated with the each PTRS port of the N PTRS ports comprises:
determining, based on demodulation reference signal (DMRS)-PTRS association indication information in DCI, a transport layer associated with the PTRS port from a first transport layer set, wherein the first transport layer set comprises transport layers transmitted on an antenna port associated with the PTRS port.

18. The terminal device according to claim 13, wherein determining the power boosting value of the each PTRS port of the N PTRS ports comprises:
determining that the power boosting value of the each PTRS port is 10*lg (N) dB in a case where a non-coherent codebook is configured.
